(19) United States
(12) Patent Application Publication
(10) Pub. No.: US 2012/0045328 A1
(43) Pub. Date: Feb. 23, 2012

(54) POWER TRANSMISSION SYSTEM

(75) Inventor: Majid Rashidi, Pepper Pike, OH (US)

(73) Assignee: CLEVELAND STATE UNIVERSITY, Cleveland, OH (US)

(21) Appl. No.: 13/102,493

(22) Filed: May 6, 2011

Related U.S. Application Data
(60) Provisional application No. 61/374,327, filed on Aug. 17, 2010.

(51) Int. Cl. F03D 11/02; F16L 41/00; F04D 13/02

(52) U.S. Cl. 416/1; 416/170 R; 137/561 A

(57) ABSTRACT

A wind turbine transmission system includes a rotor, at least one hydraulic pump coupled to the rotor, a branch manifold, a plurality of hydraulic motors, and a plurality of generators each coupled to at least one of the plurality of hydraulic motors. The branch manifold includes a trunk portion defining a main flow path connected to an outlet port of the hydraulic pump and a plurality of branch portions each defining a branch flow path extending from the main flow path and connected to an inlet port of at least one of the hydraulic motors to provide fluid communication between the hydraulic pump and the plurality of hydraulic motors.

### CROSS-REFERENCE TO RELATED APPLICATIONS

This application claims the benefit of U.S. Provisional Patent Application Ser. No. 61/374,327, entitled POWER TRANSMISSION SYSTEM and filed Aug. 17, 2010, the entire disclosure of which is incorporated herein by reference.

### BACKGROUND

Wind turbines have long been used to generate electricity from wind energy. To maximize the amount of wind energy harnessed, a conventional large scale wind turbine employs a large bladed rotor (e.g., as large as 300 ft in diameter) to deliver a low rotational speed (e.g., about 20-60 rpm as a result of up to 20 mph winds), high torque to a conventional electrical energy generator. As a conventional generator is designed to operate at a much higher rotational speed (e.g., 1200-1800 rpm), a gear box or speed increasing mechanism is conventionally used between the rotor and the generator to provide the required rotational input for the generator. While such gear box arrangements may be durable and cost effective in relatively small scale, lower torque applications, gear boxes for large scale wind turbines, often producing power on the order of 5 MW or 6,705 horsepower while requiring as much as a 90:1 gear ratio, are generally costly to manufacture. These gear box arrangements are also prone to mechanical failure, with associated maintenance costs and down time caused by, for example, mechanical stresses produced by extreme changes in wind conditions.

In other embodiments, the above described gear-driven mechanical transmission system is replaced by a hydraulic pump coupled to a wind turbine rotor to deliver pressurized hydraulic fluid flow to a hydraulic motor, which delivers an output rotary torque to power the electrical energy generator. In an open loop hydraulic system (i.e., hydraulic fluid is not recirculated), the conventional hydraulic pump still requires substantial input speeds (e.g., 300-500 rpm) to produce sufficient hydraulic pressure for the hydraulic motor, thereby still necessitating a gearbox or other mechanical speed increaser, albeit one of a lesser gear ratio than the conventional mechanical transmission system. In closed loop hydraulic systems, in which hydraulic fluid recirculated back to the hydraulic pump provides increased fluid pressure at reduced rotor velocities, heat generated from the resulting high velocity of the hydraulic fluid may be extreme, requiring expensive cooling systems that may present additional maintenance issues.

Another challenge in generating electricity from wind energy is the variability and inconsistency of wind speeds, resulting in wide variations in output torque by the rotor of the wind turbine. To power a fixed speed generator, various mechanisms have been utilized to provide a constant input speed to the generator, including, for example, blade control systems, rotor braking systems, hydraulic pressure control systems, and variable displacement motors and pumps. These efforts to provide consistent input to the generators come at the cost of reduced efficiencies, as reduced torque input produces reduced energy output, and/or energy is expended to dampen or modulate the input to the generators.

### SUMMARY

The present application describes transmission systems configured to provide efficient, reliable, and adaptable wind turbine power generation while avoiding the costs and maintenance problems of the conventional mechanical gear-driven, open loop hydraulic, or closed loop hydraulic transmission systems, or the reduced efficiencies of an output speed dampened transmission system, or both. In accordance with an aspect of the present application, an improved power transmission system for a wind turbine may include a closed loop hydraulic system having a branch manifold selected to divide the total volumetric flow rate of a hydraulic flow source (e.g., a hydraulic pump) into a plurality of hydraulic branch lines or channels. The resulting reduced volumetric flow rates through these multiple outlet branches of the hydraulic system manifold may then be used to drive multiple corresponding hydraulic motors. The output torque of these hydraulic motors may then be used to drive multiple corresponding electrical energy generators. Depending on the expected output speed of the hydraulic motors, gearboxes or other speed increasing mechanisms may be utilized to increase the rotational speed for a desired input to each of the electric generators. In accordance with another aspect of the present application, an improved power transmission system for a wind turbine may include a plurality of rotor-driven hydraulic cylinder pumps, which may be provided in an out-of-phase actuation relationship to provide increased and more consistent output of pressurized hydraulic fluid to a hydraulic motor or hydraulic fluid-driven generator.

According to one embodiment of the present application, a wind turbine transmission system includes a rotor, at least one hydraulic pump coupled to the rotor, a branch manifold, a plurality of hydraulic motors, and a plurality of electric generators each coupled to at least one of the plurality of hydraulic motors. The branch manifold includes a trunk portion defining a main flow path connected to an outlet port of the hydraulic pump and a plurality of branch portions each defining a branch flow path extending from the main flow path and connected to an inlet port of at least one of the hydraulic motors to provide fluid communication between the hydraulic pump and the plurality of hydraulic motors.

According to another embodiment of the present application, a method of generating power from a variable speed wind turbine is provided, in which a rotor is positioned to face a wind current, with the rotor being coupled to at least one hydraulic pump to pump a hydraulic fluid. The pumped hydraulic fluid is divided into a plurality of branch flow paths, and then directed through each of the plurality of branch flow paths to at least one of a plurality of hydraulic motors to drive the plurality of hydraulic motors to produce an output torque. The output torque of each of the plurality of hydraulic motors is applied to at least one of a plurality of electric generators for generating electric power.

According to still another embodiment of the present invention, a branch manifold includes a trunk portion defining a main flow path and a plurality of branch portions each defining a branch flow path. The plurality of branch portions collectively form a transition zone in which each branch flow path is collinear with the main flow path, and in which a total cross-sectional flow area of the branch flow paths relative to the cross-sectional area of the main flow path is sufficient to minimize turbulence or eliminate eddy currents within the manifold. In one such embodiment, the a total cross-sectional flow area of the branch flow paths is substantially equal to the cross-sectional area of the main flow path.

According to yet another embodiment of the present application, a wind turbine transmission system includes a rotor, a plurality of reciprocating hydraulic cylinder pumps coupled to the rotor, at least one hydraulic motor having an inlet port connected to the discharge ports of the plurality of reciprocating hydraulic cylinder pumps, and at least one generator coupled to the at least one hydraulic motor.

### BRIEF DESCRIPTION OF THE DRAWINGS

Further features and advantages of the invention will become apparent from the following detailed description made with reference to the accompanying drawings, wherein:

FIG. 1A is a schematic view of a large scale wind turbine power transmission system;

FIG. 1B is a schematic view of another large scale wind turbine power transmission system;

FIG. 1C is a schematic view of still another large scale wind turbine power transmission system;

FIG. 1D is an enlarged partial schematic view of another large scale wind turbine power transmission system;

FIG. 2 is a side cross-sectional schematic view of a manifold for a hydraulic transmission system;

FIGS. 2A, 2B, and 2C are end cross-sectional views of the manifold of FIG. 2;

FIG. 3A is a schematic view of a double acting reciprocating hydraulic cylinder pump, shown in a forward stroke condition;

FIG. 3B is a schematic view of the pump of FIG. 3A, shown in a reverse stroke condition;

FIG. 3C is a partial schematic view of another double acting reciprocating hydraulic cylinder pump;

FIG. 3D is an enlarged partial schematic view of the pump of FIG. 3C, shown in an over-pressurized forward stroke condition;

FIG. 3E is an enlarged partial schematic view of the pump of FIG. 3C, shown in an over-pressurized reverse stroke condition;

FIG. 4 is a schematic view of a rotor-driven double acting reciprocating hydraulic cylinder pump;

FIG. 5 is a rear schematic view of a wind turbine provided with two hydraulic reciprocating pumps;

FIG. 5A is an enlarged view of the hydraulic reciprocating pumps and slider crank mechanism of the wind turbine of FIG. 4; and

FIG. 6 is a partial rear schematic view of a wind turbine provided with four hydraulic reciprocating pump.

### DETAILED DESCRIPTION OF THE INVENTION

This Detailed Description of the Invention merely describes embodiments of the invention and is not intended to limit the scope of the claims in any way. Indeed, the invention as claimed is broader than and unlimited by the preferred embodiments, and the terms used in the claims have their full ordinary meaning For example, while specific embodiments shown and described in the present application relate to power transmission systems for large scale wind turbines, the inventive features described herein may be applied to other power generation transmission systems and to other variable input speed transmission systems.

The present application contemplates a variable input speed (e.g., wind-generated) power transmission system in which large scale gear boxes (as used in conventional mechanical gear-driven transmission systems) are avoided, and excessive heat generation (as experienced in hydraulic transmission systems) is minimized. In one embodiment, rotor-driven hydraulic fluid is branched or divided into multiple channels or hydraulic lines to reduce the flow rate of the hydraulic fluid, which effectively limits heat generation in the hydraulic fluid. These hydraulic fluid branched portions may then each feed smaller hydraulic transmission systems that generate rotational power for generation of electrical energy at corresponding generators. The branch hydraulic transmission systems may be variable displacement transmission systems, for example, using variable displacement hydraulic motors to generate constant frequency electrical current in generators coupled to the hydraulic motors.

By dividing a large, wind turbine blade generated mechanical energy while in a fluidic state, the excessive heat generation associated with high velocity re-circulating hydraulic fluid may be avoided. Further, any output rotational speed produced by the divided hydraulic lines (e.g., produced by hydraulic motors coupled to each of the hydraulic lines) may be increased (as necessary) using much smaller gearboxes subjected to lower levels of mechanical stresses and reduced resistance to the resulting increased torque than those present in a conventional large scale mechanical gear-driven transmission system. Still further, the division of rotor-driven hydraulic fluid into multiple power generating channels may allow for selective variability of generator operation, which may be proportional to the input rotor torque, by limiting generator operation less than all of the multiple electrical energy generators. This proportionality may reduce or eliminate the need to modulate or dampen the rotational output torque supplied to each generator, a common inefficiency associated with the variable input speed of wind power generation.

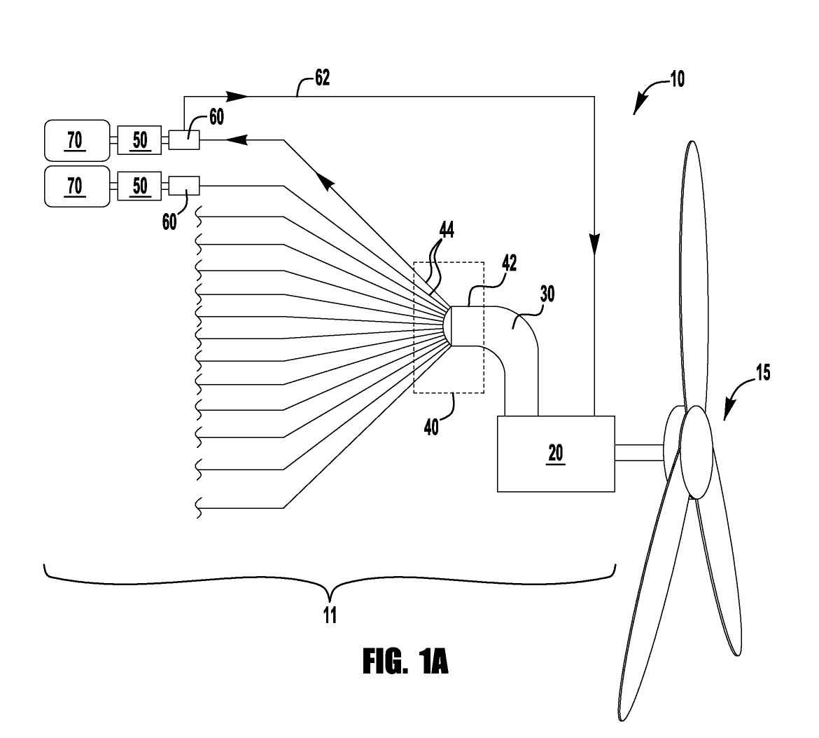

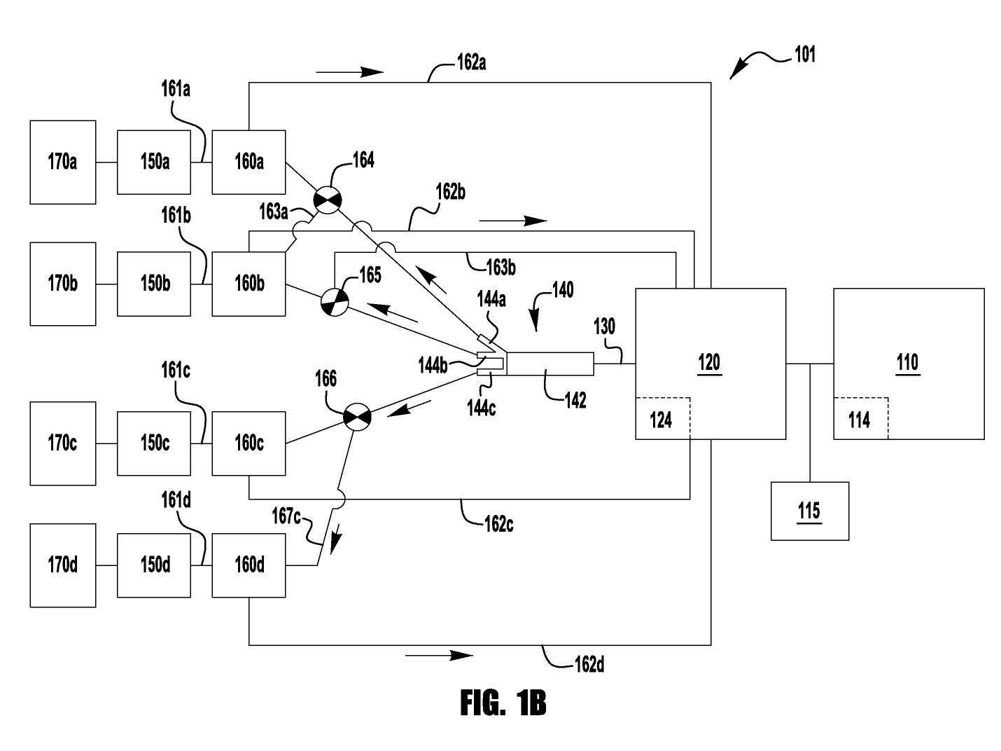

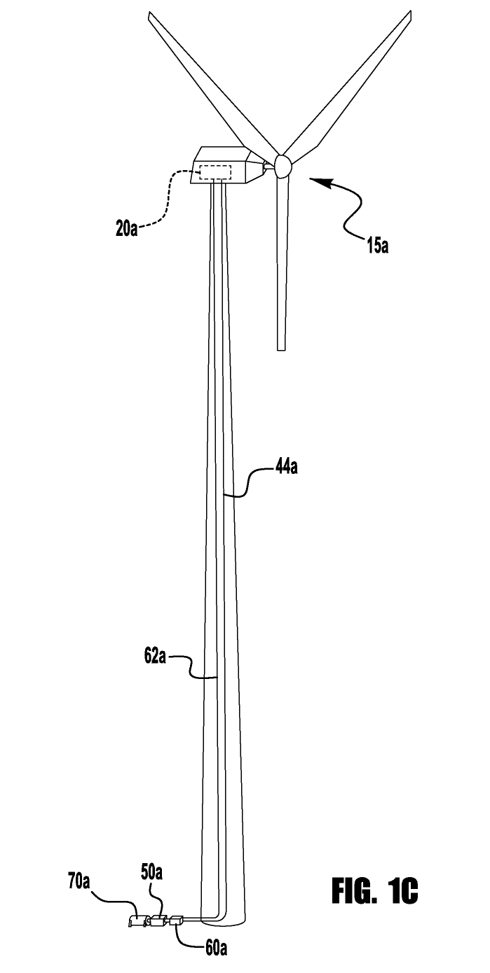

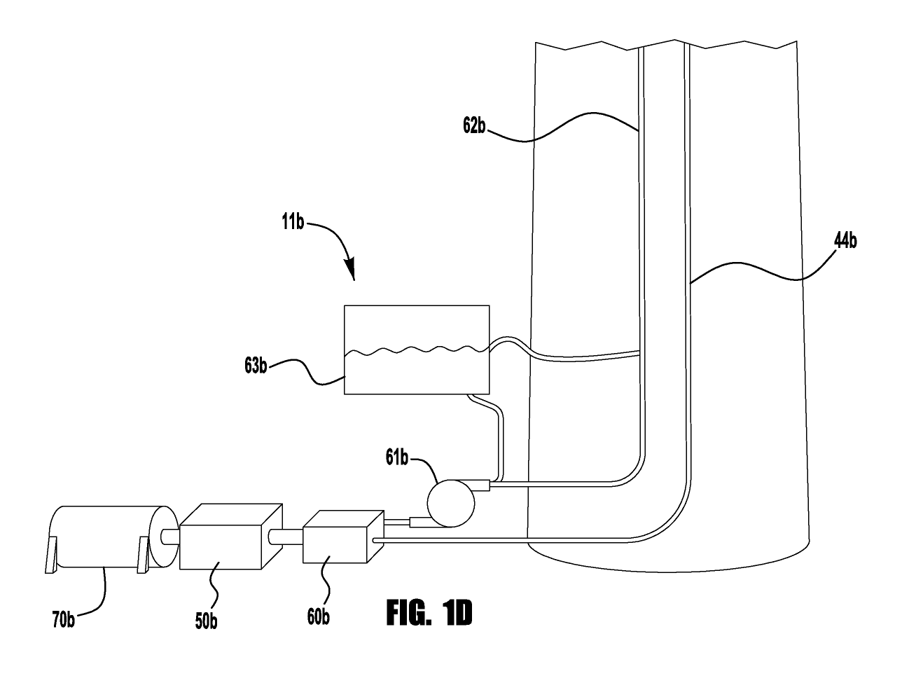

A general schematic view of a large scale wind turbine 10 with a transmission system 11 utilizing at least some of the features described herein is illustrated in FIG. 1A. The system 10 includes a rotor 15 positionable in a wind stream to drive the rotor 15 using, for example, a plurality of blades. The transmission system 11 includes a hydraulic pump 20 that is coupled to the rotor 15, such that the rotor 15 drives the pump 20 (directly or indirectly) to pump hydraulic fluid through a main line 30 at a high volumetric flow rate. The main line 30 extends to a branch manifold 40, which divides the pumped hydraulic fluid from a trunk portion 42 into two or more branch portions 44 for reduced volumetric flow rates of the pressurized hydraulic fluid in each branch portion. Each branch portion 44 supplies pumped hydraulic fluid to a corresponding hydraulic motor 60, with a return line 62 delivering the hydraulic fluid back to the pump 20. Each motor 60 is coupled to a corresponding electric generator 70 for generation of electrical power. In a conventional generator requiring elevated input shaft speed, a gearbox or other gear reducing mechanism 50 may be employed to provide an increased shaft rotation speed to each generator.

A more developed schematic view of a large scale wind turbine 100 utilizing a power transmission system 101 is illustrated in FIG. 1B. The wind turbine 100 includes at least one rotor 110 positionable in a wind stream to drive the rotor 110 using, for example, a plurality of blades. A hydraulic pump 120 (for example, a variable displacement hydraulic pump) is coupled to the rotor 110, such that the rotor 110 drives the pump 120 (directly or indirectly) to pump hydraulic fluid through a main line 130 at a high volumetric flow rate. The main line 130 extends to a branch manifold 140, which divides the pumped hydraulic fluid from a trunk portion 142 into two or more branch portions 144a-c for reduced volumetric flow rates of the pressurized hydraulic fluid in each branch portion. Each branch portion 144a-c supplies pumped hydraulic fluid to a corresponding hydraulic motor 160a-c to turn an output shaft 161a-c. A return line 162a-c connecting each hydraulic motor 160a-c with the fluid input of the hydraulic pump 120 completes a fluid circuit by delivering pressurized, low flow hydraulic fluid back to the pump 120. Each motor output shaft 161a-c is coupled to a corresponding electric generator 170a-c for generation of electrical power. In a conventional generator requiring elevated (e.g., 1200 rpm or 1800 rpm) input shaft speed, a gearbox or other gear reducing mechanism 150a-c may be employed to provide an increased shaft rotation speed to each generator. In other embodiments, one or more hydraulic fluid-driven generators may be provided in place of the hydraulic motors and rotary driven electric generators described above.

In one embodiment, an entire power transmission system (including one or more hydraulic pumps, motors, gearboxes and electrical energy generators) for a large scale wind turbine may be retained within a wind turbine housing proximate to or elevated with the rotor. This may facilitate recirculation of the pressurized hydraulic fluid. In another embodiment, as shown in FIG. 1C, a hydraulic pump 20a may be elevated with the rotor 15a within a turbine housing 19a, and configured to pump pressurized hydraulic fluid through a transmission line 44a and down to one or more hydraulic motors 60a at ground level (or underground), which in turn drive one or more electrical energy generators 70a (directly or through a gearbox or other gear reducing mechanism 50a), also at ground level (or underground). The pumped hydraulic fluid is returned to the pump 20a through a return line 62a extending back toward the elevated pump 20a and rotor 15a. Such an arrangement may alleviate space and support constraints for the transmission system components, and may facilitate maintenance or repairs performed on these components.

As shown in the embodiment of FIG. 1D, to protect the transmission system 11b against cavitation resulting from large pressure drops across the return line 62b, a fluid return mechanism 61b may be utilized to assist in returning the hydraulic fluid to the pump. The fluid return mechanism 61b may be selected to maintain a low flow velocity of the hydraulic fluid. For example, a scavenge pump, hydraulic screw pump, or other such fluid elevating device may be utilized to elevate the returned fluid within the return line 62b. Further, to protect the transmission system against high pressure surges in the return line 62b, the return line may be connected with a reservoir 63b, which receives excess hydraulic fluid, for example, through a relief valve configured to release a portion of the fluid at an elevated pressure, or in response to the detection of pressure surges by a sensor.

According to another aspect of the present application, a branched hydraulic transmission system may be configured to accommodate variations in hydraulic pressure resulting from variations in wind speed acting on the rotor. At lower wind speeds, the power transmission system may operate to utilize fewer of the hydraulic motors and corresponding electric energy generators. In one such example, the power transmission system is provided with a sensor for measuring wind speed, hydraulic pressure, or some other condition proportional to or corresponding to wind speed at the rotor. As one example, referring back to FIG. 1B, the pump 120 may be provided with a pressure sensor 124 to measure an output pressure of the pump. Additionally or alternatively, the rotor 110 may be provided with a tachometer 114 or other such sensor to measure a rotational speed of the rotor. When the measured condition drops below a threshold value, a branched hydraulic fluid flow may be diverted (e.g., by a switching valve 164) away from at least one selectively “deactivated” hydraulic motor 160a, 160b for direct return to the hydraulic pump 120 (e.g., by bypass line 163b) or for supplying directly to at least one still active hydraulic motor 160b (e.g., by bypass line 163a), or both. This may provide more consistent and/or effective fluid pressure to the active hydraulic motors for more efficient energy production. When the measured condition increases above a threshold value, the branched hydraulic fluid flow may be redirected to the corresponding hydraulic motor for increased energy generation. By diverting fluid flow to additional transmission system branches in response to higher system pressures (e.g., due to higher wind velocities), the need to relieve excess fluid pressure (e.g., by dumping hydraulic fluid to reduce pressure) is eliminated or reduced, while utilizing this elevated pressure to produce additional power. Additionally, the system may be provided with an emergency shut-off or braking system 115, as known in the art, to protect the rotor, pump, and transmission system in the event of extreme wind velocities.

Additionally, one or more sets of hydraulic motors and generators may be provided as back-ups configured to be placed in service when one or more of the active hydraulic motors and/or generators malfunctions or is undergoing service maintenance or replacement. For example, if an active motor 160c or generator 170c needs to be taken off-line, the branched pressurized fluid may be diverted (e.g., by a switching valve 166) away from the deactivated motor 106c and toward the back-up motor 160d (e.g., by bypass line 167c). As a result, one or more of the hydraulic motors and/or generators may be serviced or replaced without shutting down the entire system. A return line 162d connecting the back-up hydraulic motor 160d with the fluid input of the hydraulic pump 120 may be utilized to complete a fluid circuit.

While the exemplary schematic illustration of FIG. 1B shows a system with three branched flow paths delivering hydraulic fluid to three hydraulic motors, and one backup motor and generator, any number of branched flow paths may be utilized to divide the desired total power output into portions that provide the desired scalability of power generation, and/or are more easily managed by conventional hydraulic motors and electrical energy generators. For example, a large scale rotor and hydraulic pump selected to provide a total power output of up to 5 MW (or 6,705 hp) may utilize a branch manifold arrangement selected to divide the total power generation into fourteen portions of up to 480 hp each, which may be easily managed by conventional gearboxes and generators rated for up to 500 hp. These conventional gearboxes and generators may be significantly less expensive, more readily available, and more easily maintained than a single gearbox and generator rated for up to 5 MW of power generation. Additionally, any number of backup motor and generator assemblies may be utilized to temporarily replace deactivated assemblies, or to accommodate increased fluid pressures or flow rates.

Further, while the schematic illustration of FIG. 1B shows a “one-to-one” relationship between each hydraulic motor 160a-d and a corresponding gearbox 150a-d and generator 170a-d, other arrangements may additionally or alternatively be provided. For example, in other embodiments, multiple hydraulic motors may be coupled to a single electrical generator, or a hydraulic motor may be coupled to multiple electrical generators.

While many different types of branch manifolds may be utilized to divide rotor-pumped hydraulic fluid for driving multiple hydraulic motors, in one inventive embodiment, a branch manifold may be configured to minimize drops in pressure through the manifold, as well as increases in eddy currents and turbulence and flow velocity, conditions which may result in significant temperature increases. By minimizing these temperature increases, the wear and damage to the transmission system associated with extreme temperatures may be reduced or eliminated. In one embodiment, a branch manifold includes a transition zone in which a branch manifold trunk portion is divided into multiple branches while minimizing any fluid pressure drop or turbulence during branching. For example, pressure drop and turbulence may be reduced by minimizing the changes in cross-sectional flow area from the inlet or trunk portion of the manifold to the branch portions of the manifold, and/or by minimizing or eliminating any bends or obstructions in the flow paths. By minimizing pressure drops and turbulence, the branch hydraulic fluid flow may maintain elevated pressures and relatively low flow rates, thereby minimizing temperature increases of the hydraulic fluid. Once the pumped hydraulic fluid has been divided into several smaller flow paths with lower flow rates, pressure drops associated with changes to the cross sectional flow area, and changes in orientation or obstructions in the flow paths are less likely to generate excessive heat.

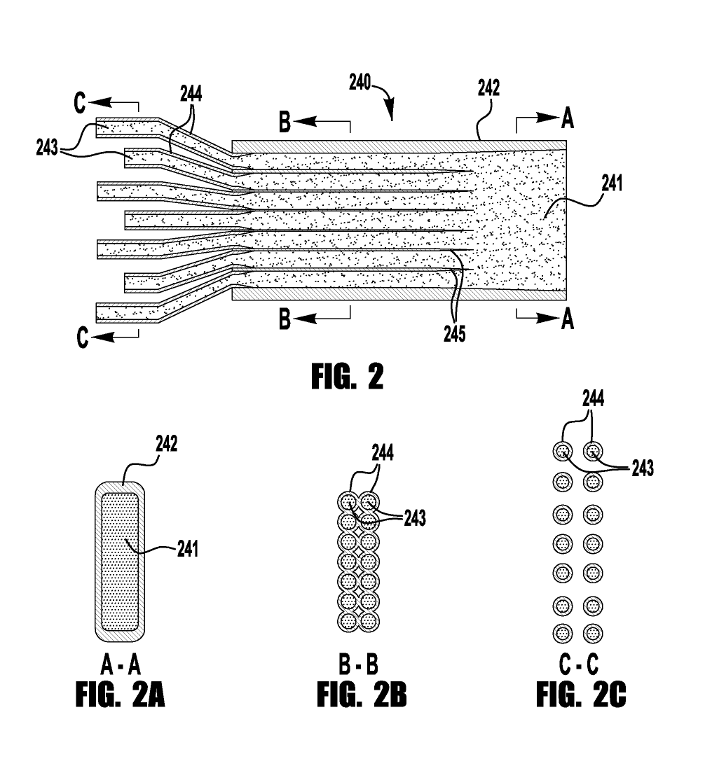

FIGS. 2 and 2A-2C illustrate various views of an exemplary branch manifold 240 having an inlet or trunk portion 242 defining a main flow path 241 and multiple outlet or branch portions 244 defining branch flow paths 243. As evident in FIG. 2, the trunk portion 242 may be initially divided into branch portions 244 by a series of thin-edged plates or blades 245, designed to minimize the blockage or obstruction of fluid passing from the trunk portion 242 into the branch portions 244. Within at least a portion of this transition zone, the divided branch flow paths 243 may collectively maintain a cross-sectional flow area that is sufficient, relative to the cross-sectional flow area of the main flow path 241, to minimize turbulence or eliminate eddy currents within the fluid flow. In one example, the divided branch flow paths 243 have a combined cross-sectional flow area that is nearly the same as or substantially equal to the cross-sectional flow area of the main flow path 241. In other examples, the divided branch flow paths 243 may have a combined cross-sectional flow area that is less than the cross-sectional flow area of the main flow path 241, but still sufficient to minimize turbulence or eliminate eddy currents within the fluid flow.

In one such embodiment, the main flow path 241 and blade separated portions of the branch flow paths are rectangular in cross-section to minimize the blockage of the fluid flow from the main flow path into the branch flow paths. Further into a transition zone (e.g., at B-B), the blades 245 may gradually thicken to provide greater support for the contained fluid, and the branch portions 244 may be contoured to form cylindrical tubular portions. Additionally, the divided branch flow paths 243 in the transition zone may each be parallel with and collinear with (i.e., axially aligned with a portion of) the main flow path 241, as shown, to eliminate bends in the flow paths and any resulting turbulence or pressure drops in this transition zone. This transition zone may be maintained for a suitable distance to minimize upstream pressure drops at the trunk portion, where the much larger volumetric flow rate is more susceptible to overheating at increased flow velocities. In one embodiment, the distance of the transition zone may be selected to be directly proportional to (e.g., a multiple of) the square root of the flow area at the trunk portion (for example, approximately 2-3 times the square root of the flow area), or selected to be directly proportional to (e.g., a multiple of) a primary cross-sectional dimension of a flow area (for example, approximately 3 times the diameter of a circular cross-sectional flow area). Beyond the transition zone (e.g., at C) the branch portions 244 may be gradually angled outward and spaced apart from each other to direct branched fluid to the hydraulic motors.

Many different hydraulic pump arrangements may be coupled to a variable speed wind turbine rotor to deliver pressurized hydraulic fluid either directly to one or more hydraulic fluid-driven electrical generators or to one or more hydraulic motors that deliver a torque output to one or more electrical generators, as described above. One such hydraulic pump arrangement is a reciprocating hydraulic cylinder pump. In one embodiment, a single acting hydraulic cylinder may be used to pump hydraulic fluid to the hydraulic motor or generator. In such an arrangement, the pumping of hydraulic fluid is limited to the forward stroke of the hydraulic cylinder piston. In another embodiment, a double acting hydraulic cylinder may be used to pump hydraulic fluid during both forward and reverse strokes of the hydraulic cylinder piston for more consistent, uniform pumping.

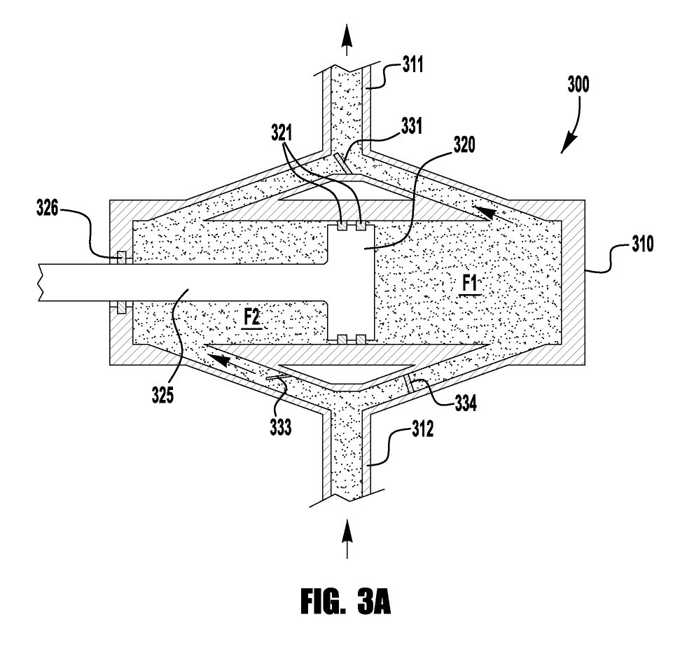

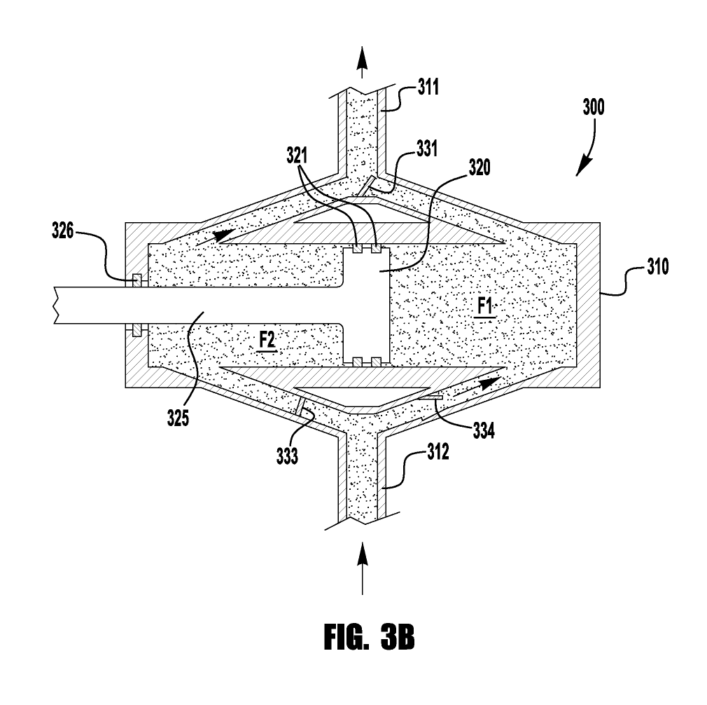

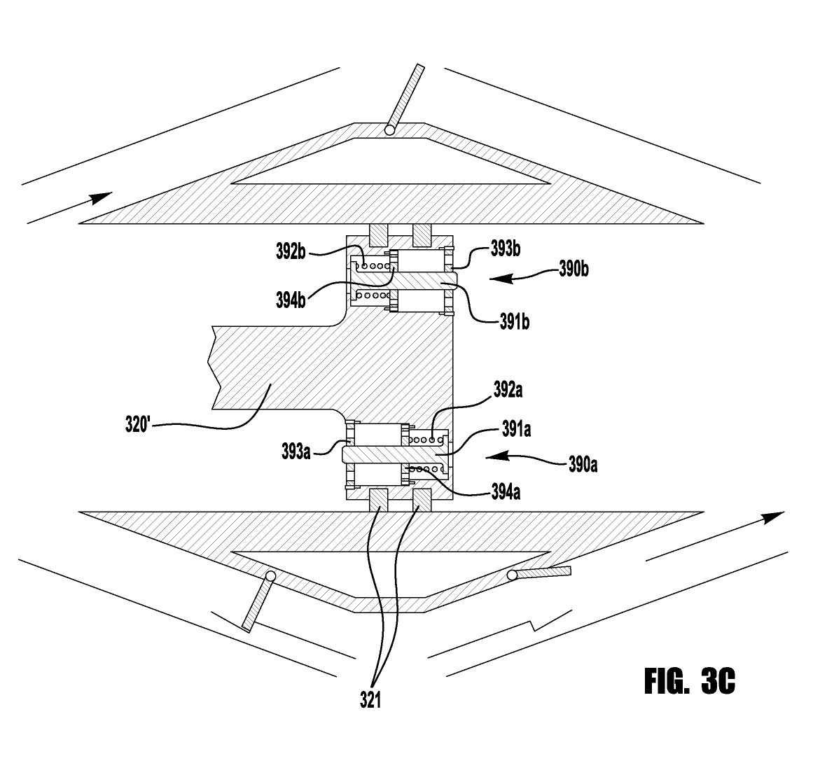

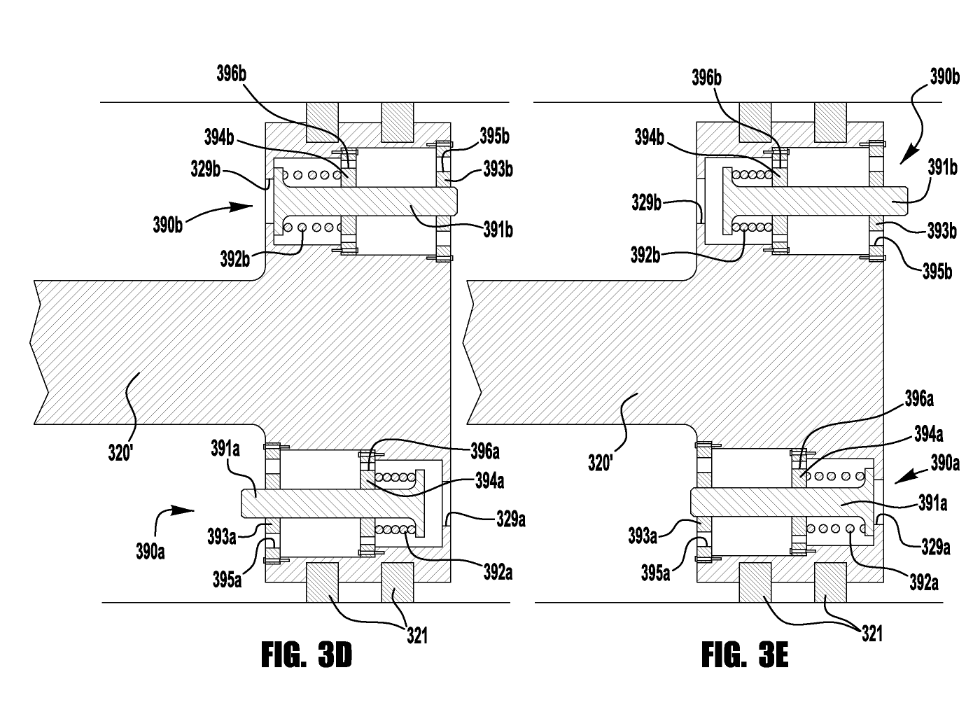

FIGS. 3A and 3B illustrate schematic views of a rotor-driven double acting reciprocating hydraulic cylinder pump 300 including a cylinder body 310 within which a piston 320 and piston rod 325 are driven, for example, by a slider crank mechanism coupled to a wind turbine rotor (as discussed in greater detail below), to pressurize a hydraulic fluid. The piston 320 and piston rod 325 seal against the cylinder body 310 using, for example, one or more gasket seals 321, 326, to separate a first fluid Fl outward of the piston 320 from a second fluid F2 inward of the piston 320. During a first or forward stroke (FIG. 3A), the piston rod 325 pushes the piston 320 towards a distal end of the cylinder body 310 to pressurize fluid Fl, forcing the fluid past switching valve 331 through discharge port 311. During this forward stroke, fluid F2 is drawn through valve 333 and into the cylinder body from the intake port 312. During a second or reverse stroke (FIG. 3B), the piston rod 325 pulls the piston 320 towards the proximal end of the cylinder body 310 to pressurize fluid F2, forcing the fluid past the switching valve 331 and through the discharge port 311. During the reverse stroke, fluid F1 is drawn through valve 334 and into the cylinder body from the intake port 312.

To protect the hydraulic cylinder pump from excessive fluid pressures (for example, resulting from excessive wind speeds), a rotor mechanism may be configured to re-direct the rotor such that it does not directly face the prevailing wind in the event of high wind conditions. In some applications, this protective reorientation of the rotor may not occur in time to protect from over-pressurization as a result of exposure of the rotor to a sudden gust of wind. Accordingly, a power transmission system may additionally or alternatively be provided with one or more pressure relief devices configured to relieve excessive fluid pressure on one side of a hydraulic pump piston by releasing fluid to the opposite side of the hydraulic pump piston.

While many different pressure relief devices may be utilized, in one embodiment, as shown in FIGS. 3C, 3D, and 3E, one or more pressure relief devices 390a, 390b are disposed within the piston 320′. In the exemplary, illustrated embodiment, the pressure relief devices 390a, 390b include stem portions 391a, 391b biased into a piston sealing position by springs 392a, 392b, and guided by apertured plates 393a, 394a, 393b, 394b. In the event of excessive fluid pressure outward of the piston 320′ (for example, due to a high velocity forward stroke caused by extreme wind gusts), the stem portion 391a of the first pressure relief device 390a is compressed against the spring 392a (as shown in FIG. 3D) to allow the higher pressure fluid to pass through the piston opening 329a and through apertures 395a, 396a in the plates 393a, 394a, thereby reducing the pressure outward of the piston 320′. In the event of excessive fluid pressure inward of the piston 320′ (for example, due to a high velocity reverse stroke caused by extreme wind gusts), the stem portion 391b of the second pressure relief device 390b is compressed against the spring 392b (as shown in FIG. 3E) to allow the higher pressure fluid to pass through the piston opening 329b and through apertures 395b, 396b in the plates 393b, 394b, thereby reducing the pressure inward of the piston 320′. The springs 392a, 392b may be selected or otherwise adjusted to provide a sufficient stem sealing force under normal wind conditions, such that the springs are only compressed under conditions of excessive fluid pressures. Any number of first and second pressure relief devices may be provided in the piston 320′ to allow for sufficient, uniform pressure relief. For example, a piston may be provided with three pressure relief devices protecting against forward stroke overpressurization, and three pressure relief devices protecting against reverse stroke overpressurization, with the pressure relief devices spaced apart around a periphery of the piston in an alternating arrangement.

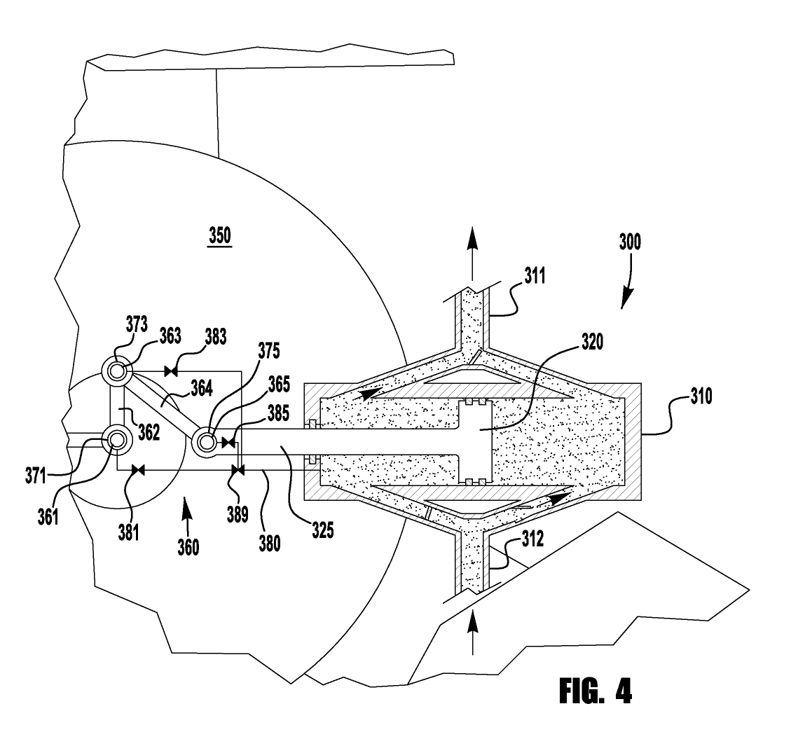

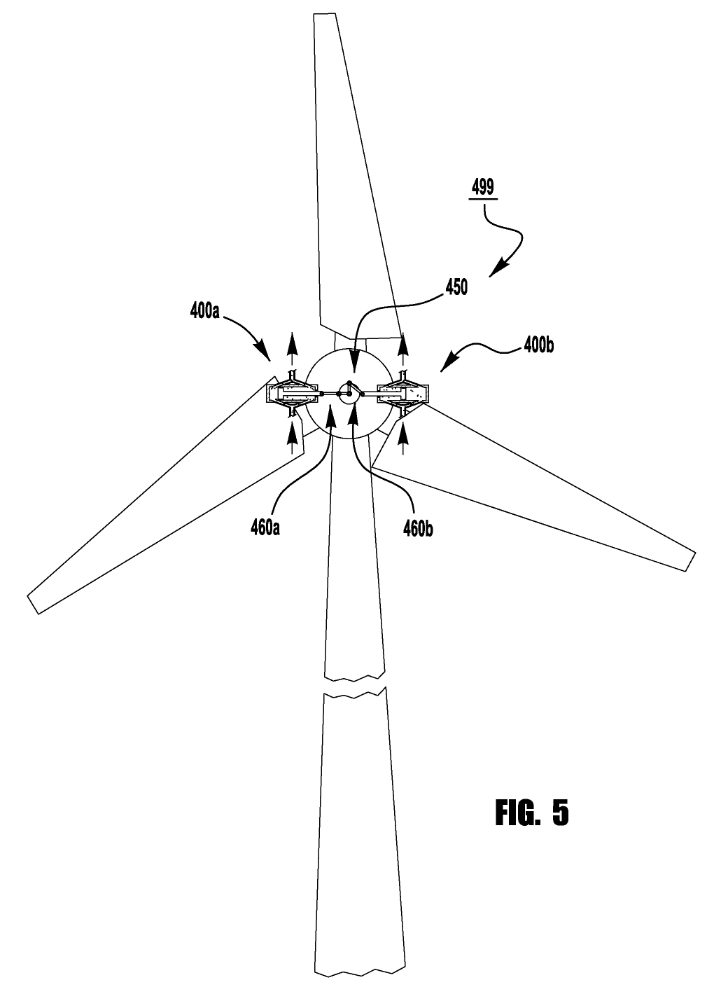

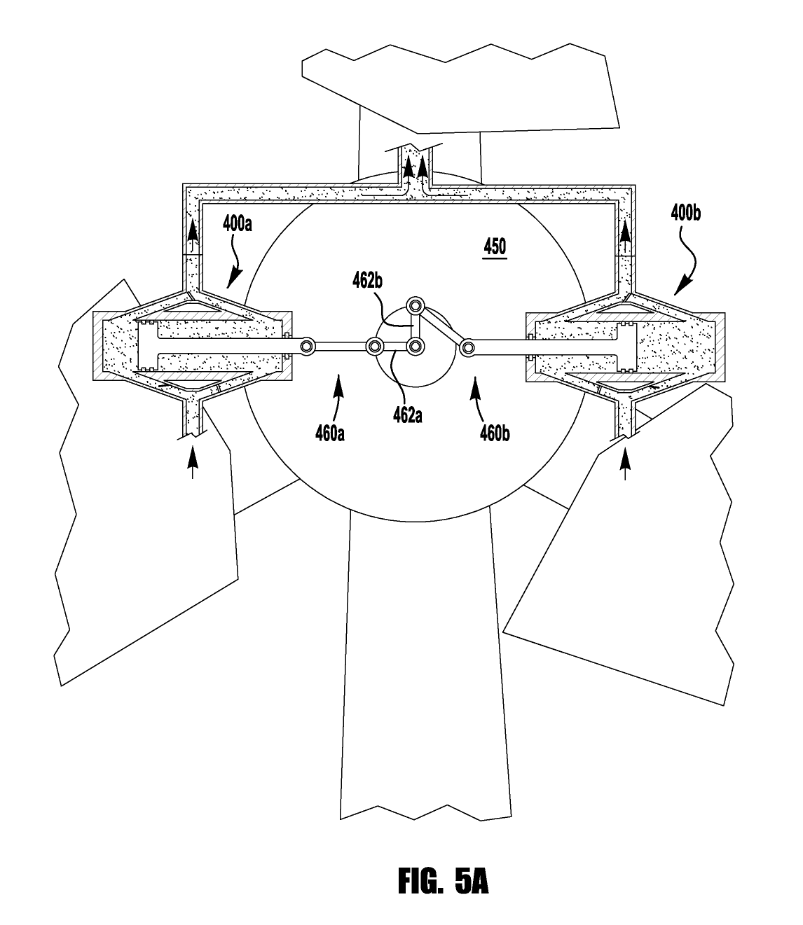

While any suitable driving mechanism may be utilized to apply rotational movement of a rotor to drive translational or sliding movement of a piston, in one embodiment, a slider crank mechanism is used to drive the piston. FIG. 4 illustrates a schematic view of a wind turbine rotor 350 coupled with a reciprocating hydraulic cylinder pump 300 using a slider crank mechanisms 360. The slider crank mechanism 360 includes a crankshaft 361 rotationally secured to the rotor 350. The crankshaft 361 is linked to a crankpin 363 by a crank 362, which is linked to a wrist pin 365 by a connecting rod 365. The wrist pin 365 is pivotally connected to the piston rod 325 of the first hydraulic cylinder pump 300 for sliding movement of the piston rod 325 in response to rotor-driven rotation of the crankshaft 361. When the rotor 350 is rotated, the crank 362 rotates to move the crankpin 363 in a circular path around the crankshaft 361, which in turn pulls (as the crankpin 363 moves away from the cylinder body 310) and pushes (as the crankpin 363 moves toward the cylinder body 310) the connecting rod 364. The connecting rod 364 pivots about the crankpin 363 and wrist pin 365 to slide the piston rod 325 and piston 320 within the cylinder body 310.

To minimize wear and prevent damage to the crankshaft, crank pins, and wrist pins of a rotor-driven slider crank mechanism, these connection points may be provided with one or more bearings to reduce friction and associated surface wear. Many different types of bearings may be utilized, including, for example, roller bearings. In one embodiment, hydrostatic bearings are provided at one or more of the crankshaft, crank pins, and wrist pins of a slider crank mechanism, providing a thin layer of hydraulic fluid to these connection points. The hydraulic fluid separates sliding surfaces from each other within these bearings, lubricates the bearing surfaces, and provides an external fluid pressure against the bearing surfaces. While the hydrostatic bearings may be provided with hydraulic fluid from a separate hydraulic pump, in one embodiment, the hydraulic cylinder pump being driven by the slider crank mechanism supplies hydraulic fluid to the slider crank connection points (i.e., the hydrostatic bearings).

In the embodiment illustrated in FIG. 4, hydrostatic bearings 371, 373, 375 are provided at the crankshaft 361, crankpin 363, and wrist pin 365. A bearing fluid supply line 380 extends from the cylinder body to provide lubricating hydraulic fluid to each of the hydraulic bearings 371, 373, 375. The bearing fluid supply line 380 may be provided with one or more valves 381, 383, 385, and 389 configured to provide a suitable amount of hydraulic fluid to each of the bearings. In one such embodiment, the valve or valves may be configured to supply hydraulic fluid in an amount proportional to the pressure generated within the cylinder body or the rate of movement of the piston 320. In such an arrangement, faster operation of the slider crank mechanism 360 results in a greater amount of lubricating hydraulic fluid being provided to the bearing surfaces. As the amount of hydraulic fluid provided to the hydrostatic bearings is very small relative to the amount of hydraulic fluid pumped out of the hydraulic cylinder, the impact of this loss of hydraulic fluid for lubrication is negligible.

In a double acting hydraulic cylinder pump, such as the pump 300 of FIGS. 3A and 3B, fluid output through the discharge port 311 approaches zero as the piston reaches the end of each stroke or “top-dead-center” position, and fluid output approaches a maximum rate as the piston 320 passes a mid-point of each stroke. As a result, while the double acting hydraulic cylinder pumps fluid during both forward and reverse strokes, reduced fluid output at the beginning and end of each stroke may result in inconsistent fluid output and reduced overall flow to the hydraulic motor or hydraulic fluid-driven generator.

In other embodiments, a wind turbine rotor may be coupled to multiple hydraulic cylinders, the outputs of which may be combined to produce an increased or more consistent hydraulic fluid output for the hydraulic motor or generator. In one such embodiment, double acting hydraulic cylinders are configured to be out of phase with each other. As a result, when the instantaneous fluid output of a first hydraulic cylinder approaches zero (i.e., at the end of each stroke of the piston), a second hydraulic cylinder provides a substantial instantaneous fluid output. Likewise, when the instantaneous fluid output of the second hydraulic cylinder approaches zero, the first hydraulic cylinder provides a substantial instantaneous fluid output. The combination of these fluid outputs (for example, to supply to a hydraulic motor or to a hydraulic fluid-driven generator) produces an increased and more consistent output of pressurized hydraulic fluid.

FIGS. 5 and 5A illustrate a schematic view of a wind turbine 499 having a rotor 450 coupled with first and second reciprocating hydraulic cylinder pumps 400a, 400b using slider crank mechanisms 460a, 460b, which may, but need not, be consistent with the slider crank mechanism 360 of FIG. 4. The illustrated slider crank mechanisms 460a, 460b are configured such that the pumps 400a, 400b are approximately 90° out of phase with each other. In other embodiments, a different out-of-phase relationship between a reciprocating hydraulic cylinder pumps may be utilized, including for example, approximately 30°, approximately 45°, or approximately 60° out-of-phase. The out-of-phase relationship between the first and second pumps 400a, 400b is determined by the angle between the first and second cranks 462a, 462b. In the illustrated embodiment, a 90° angle between the first and second cranks 462a, 462b provides a maximum fluid output from the second pump 400b when the first pump 400a is at a zero output or top-dead-center position. Likewise, this arrangement provides a maximum fluid output from the first pump 400a when the second pump is at a zero output or top-dead-center center position.

In still other embodiments, a wind turbine rotor may be coupled to three or more hydraulic cylinders, the outputs of which may be combined to produce an increased or more consistent hydraulic fluid output for the hydraulic motor or generator. In one such embodiment, each of the hydraulic cylinders may be configured to be out of phase with at least one of the other hydraulic cylinders. As a result, when the instantaneous fluid output of any one hydraulic cylinder approaches zero (i.e., at the end of each stroke of the piston), at least one of the other hydraulic cylinders provides a substantial instantaneous fluid output. The combination of these fluid outputs provided by these hydraulic cylinders (for example, to supply to a hydraulic motor or to a hydraulic fluid-driven generator) produces an increased and more consistent combined output of pressurized hydraulic fluid.

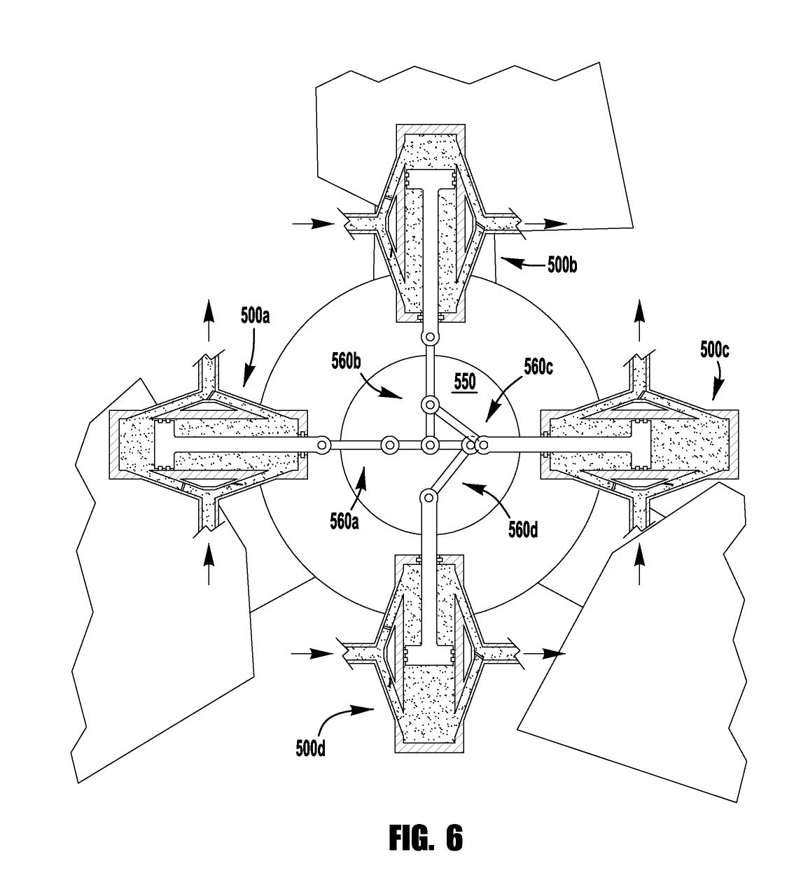

FIG. 6 illustrates a schematic view of a wind turbine rotor 550 coupled with first, second, third, and fourth reciprocating hydraulic cylinder pumps 500a, 500b, 500c, 500d using slider crank mechanisms 560a, 560b, 560c, 560d consistent with the slider crank mechanism 360 shown in FIG. 4 and described above. In the illustrated embodiment, the first and second pumps 500a, 500b are in phase with each other and approximately 90° out of phase with the third and fourth pumps 500c, 500d, which are also in phase with each other. In another embodiment (not shown), a first pump may be approximately 30° out of phase with a second pump, approximately 60° out of phase with a third pump, and approximately 90° out of phase with a fourth pump, such that no two pumps are ever within less than 15° of a zero output or “top-dead-center” position during operation of the pumps.

In rotor-driven hydraulic cylinder pump arrangements utilizing multiple hydraulic cylinder pumps, one or more of the hydraulic cylinder pumps may be selectively or automatically placed into or withdrawn from service in supplying pressurized hydraulic fluid to a hydraulic motor or hydraulic fluid-driven generator. For example, one or more hydraulic cylinder pumps may be withdrawn from service during periods of low rotor input (for example, due to low wind) in which one or more hydraulic motors or generators have likewise been withdrawn from service, as discussed in greater detail above. As another example, one or more hydraulic cylinder pumps may be withdrawn from service to prevent overpressurization of the hydraulic motor or generator during periods of high rotor input (for example, due to high winds).

Hydraulic cylinder pumps may be withdrawn from service in many different ways. As one example, fluid output from the discharge port may be selectively or automatically diverted away from the hydraulic motor or hydraulic fluid-driven generator, using switching valves or other suitable fluid control devices, for recirculation of the pressurized fluid back to the intake port. As another example, the crankshaft of a slider crank mechanism for a hydraulic cylinder pump may be selectively or automatically detached or disengaged from the rotor to prevent operation of the pump.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

What is claimed is:

1. A wind turbine transmission system comprising:
a rotor;
at least one hydraulic pump coupled to the rotor;
a branch manifold having a trunk portion defining a main flow path connected to an outlet port of the hydraulic pump and a plurality of branch portions each defining a branch flow path extending from the main flow path;
a plurality of hydraulic motors each having an inlet port connected to at least one of the branch flow paths to provide fluid communication between the hydraulic pump and the plurality of hydraulic motors; and
a plurality of generators each coupled to at least one of the plurality of hydraulic motors.

2. The system of claim 1, further comprising a plurality of fluid return lines each connecting an outlet port of at least one of the plurality of hydraulic motors to an inlet port of the hydraulic pump.

3. The system of claim 1, wherein the branch manifold includes a transition zone in which the plurality of branch flow paths have a total cross-sectional flow area that is substantially equal to a cross-sectional area of the main flow path.

4. The system of claim 1, wherein the branch manifold includes a transition zone in which the plurality of branch flow paths are collinear with the main flow path.

5. The system of claim 4, wherein the transition zone has a length of approximately two to three times a square root of a cross-sectional flow area of the main flow path.

6. The system of claim 1, further comprising a plurality of speed increasing gear mechanisms each connecting at least one of the plurality of hydraulic motors to at least one of the plurality of generators.

7. The system of any of claim 1, further comprising at least one fluid bypass line in fluid communication with at least one of branch flow paths to selectively divert hydraulic fluid from the at least one of the plurality of branch portions away from the corresponding at least one of the hydraulic motors.

8. The system of claim 7, further comprising a sensor in communication with the hydraulic pump, the sensor being configured to determine a pressure within the hydraulic pump and to direct hydraulic fluid from the at least one of the plurality of branch portions to the corresponding at least one fluid bypass line when the determined pressure is less than a predetermined threshold pressure.

9. The system of claim 7, further comprising a sensor in communication with the rotor, the sensor being configured to determine a rotational speed of the rotor and to direct hydraulic fluid from the at least one of the plurality of branch portions to the corresponding at least one fluid bypass line when the determined rotational speed is less than a predetermined threshold rotational speed.

10. The system of claim 7, wherein the at least one fluid bypass line is connected to the hydraulic pump inlet port.

11. The system of claim 7, wherein the at least one fluid bypass line is connected to the inlet port of another one of the plurality of hydraulic motors.

12. The system of claim 7, further comprising at least one switching valve connected with at least one of the branch flow paths for selectively directing hydraulic fluid to either one of the corresponding at least one hydraulic motor and the corresponding at least one fluid bypass line.

13. The system of claim 1, wherein the at least one hydraulic pump comprises a reciprocating hydraulic cylinder pump.

14. The system of claim 13, wherein the at least one hydraulic pump comprises a plurality of reciprocating hydraulic cylinder pumps.

15. The system of claim 14, wherein each of the plurality of reciprocating hydraulic cylinder pumps is out of phase with at least one of the remaining ones of the plurality of reciprocating hydraulic cylinder pumps.

16. The system of claim 15, wherein each of the plurality of reciprocating hydraulic cylinder pumps is 90° out of phase with at least one of the remaining ones of the plurality of reciprocating hydraulic cylinder pumps.

17. The system of claim 13, wherein the at least one reciprocating hydraulic cylinder pump includes a slider crank mechanism having connection points provided with hydrostatic bearings.

18. The system of claim 17, wherein hydraulic fluid is provided to the hydrostatic bearings by the at least one reciprocating hydraulic cylinder pump.

19. The system of claim 1, wherein the at least one hydraulic pump is vertically aligned with the rotor, the plurality of hydraulic motors being vertically spaced apart from the hydraulic pump.

20. The system of claim 19, further comprising a fluid elevating device connected with the plurality of hydraulic motors, the fluid elevating device being configured to return hydraulic fluid from the plurality of hydraulic motors to the at least one hydraulic pump.

21. A method of generating power from a variable speed wind turbine, the method comprising:
positioning a rotor to face a wind current, the rotor being coupled to a hydraulic pump to pump a hydraulic fluid;
dividing the pumped hydraulic fluid into a plurality of branch flow paths;
directing the pumped hydraulic fluid through each of the plurality of branch flow paths to at least one of a plurality of hydraulic motors to drive the plurality of hydraulic motors; and
applying an output torque of each of the plurality of hydraulic motors to at least one of a plurality of generators for generating power.

22. The method of claim 21, further comprising determining a rotational speed of the rotor and diverting the pumped hydraulic fluid away from at least one of the plurality of hydraulic motors when the determined rotational speed is less than a predetermined threshold rotational speed.

23. The method of claim 21, further comprising determining a pressure within the hydraulic pump and diverting the pumped hydraulic fluid away from at least one of the plurality of hydraulic motors when the determined pressure is less than a predetermined threshold pressure.

24. The method of claim 21, further comprising recirculating the pumped hydraulic fluid from the plurality of hydraulic motors back to the hydraulic pump.

25. The method of claim 21, wherein dividing the pumped hydraulic fluid into the plurality of branch flow paths comprises directing the pumped hydraulic fluid through a branch manifold having a trunk portion defining a main flow path and a plurality of branch portions each defining one of the plurality of branch flow paths.

26. The method of claim 25, wherein the branch manifold includes a transition zone in which the plurality of branch flow paths have a total cross-sectional flow area that is substantially equal to a cross-sectional area of the main flow path.

27. The method of claim 25, wherein the branch manifold includes a transition zone in which the plurality of branch flow paths are collinear with the main flow path.

28. The method of claim 27, wherein the transition zone has a length of approximately two to three times a square root of a cross-sectional area of the main flow path.

29. The method of claim 27, wherein the rotor is coupled to a plurality of reciprocating hydraulic cylinder pumps.

30. The method of claim 29, further comprising combining the pumped hydraulic fluid from the plurality of reciprocating hydraulic cylinder pumps into a main flow path upstream from the plurality of branch flow paths.

31. The method of claim 29, wherein each of the plurality of reciprocating hydraulic cylinder pumps is out of phase with at least one of the remaining ones of the plurality of reciprocating hydraulic cylinder pumps.

32. A branch manifold comprising:
a trunk portion defining a main flow path; and
a plurality of branch portions each defining a branch flow path, the plurality of branch portions collectively forming a transition zone in which each of the branch flow paths is collinear with the main flow path, and in which a total cross-sectional flow area of the branch flow paths is substantially equal to a cross-sectional area of the main flow path.

33. The branch manifold of claim 32, wherein the transition zone has a length of approximately two to three times a square root of a cross-sectional area of the main flow path.

34. A wind turbine transmission system comprising:
a rotor;
a plurality of reciprocating hydraulic cylinder pumps coupled to the rotor, with each of the plurality of reciprocating hydraulic cylinder pumps including an intake port and a discharge port;
at least one hydraulic motor having an inlet port connected to at least one of the plurality of discharge ports to provide fluid communication between the plurality of reciprocating hydraulic cylinder pumps and the at least one hydraulic motor; and
at least one generator coupled to the at least one hydraulic motor.

35. The system of claim 34, wherein each of the plurality of reciprocating hydraulic cylinder pumps is out of phase with at least one of the remaining ones of the plurality of reciprocating hydraulic cylinder pumps.

36. The system of claim 35, wherein each of the plurality of reciprocating hydraulic cylinder pumps is 90° out of phase with at least one of the remaining ones of the plurality of reciprocating hydraulic cylinder pumps.

37. The system of claim 34, wherein at least one of the plurality of reciprocating hydraulic cylinder pump includes a slider crank mechanism having connection points provided with hydrostatic bearings.

38. The system of claim 37, wherein hydraulic fluid is provided to the hydrostatic bearings by the at least one reciprocating hydraulic cylinder pump.

39. The system of claim 34, wherein at least one of the plurality of reciprocating hydraulic cylinder pumps includes a piston having first and second pressure relief devices disposed in the piston, the first pressure relief device permitting reverse flow through the piston as a result of fluid overpressurization outward of the piston, and the second pressure relief device permitting forward flow through the piston as a result of fluid overpressurization inward of the piston.
